(19) United States
(12) Patent Application Publication
(10) Pub. No.: US 2024/0245264 A1
(43) Pub. Date: Jul. 25, 2024

(54) AUTOMATIC SAUCE SUPPLY DEVICE AND SAUCE STORAGE FACILITY PROVIDED WITH SAME

(71) Applicant: TECHMAGIC INC., Tokyo (JP)

(72) Inventors: Eiji ISHIWATA, Tokyo (JP); Kohei YOKOUCHI, Tokyo (JP)

(21) Appl. No.: 18/626,338

(22) Filed: Apr. 4, 2024

Related U.S. Application Data
(63) Continuation of application No. PCT/JP2022/032749, filed on Aug. 31, 2022.

(30) Foreign Application Priority Data
Oct. 6, 2021 (JP) 2021-164722

(51) Int. Cl. A47J 43/042; A47J 43/07

(52) U.S. Cl. CPC A47J 43/042; A47J 43/07

(57) ABSTRACT

An automatic sauce supply device that automatically supplies a cooking container with sauce in a well-agitated state and sauce storage facility provided with the same are provided. An automatic sauce supply device is configured to supply a cooking container with sauce contained in a storage container. The automatic sauce supply device includes a container-holding unit configured to hold the storage container that contains the sauce, an ejection nozzle configured to eject the sauce to the cooking container, a pump configured to pump the sauce from the storage container and pressure-feed the sauce to the ejection nozzle. The container-holding unit includes a base table equipped with the pump and the ejection nozzle, a container-fixing table removably fixing the storage container, and a container-shaking mechanism configured to shake the container-fixing table with respect to the base table.

### RELATED APPLICATIONS

The present application is a continuation application of International Application Number PCT/JP2022/032749 filed Aug. 31, 2022, which claims the benefit of priority to Japanese Patent Application No. 2021-164722, filed on Oct. 6, 2021, the disclosures of which applications are hereby incorporated by reference herein in their entirety.

### TECHNICAL FIELD

The present invention relates to an automatic sauce supply device and a sauce storage facility provided with the same. Specifically, the present invention relates to an automatic sauce supply device that automatically supplies a cooking container with sauce that is used for cooking and also relates to a sauce storage facility provided with this device.

### BACKGROUND ART

In recent years, the development of a society with abundant food have been accompanied by a demand for cooking of various types of dishes using various types of ingredients. At the same time, given the circumstances in the restaurant business market, such as the need to hire of the required number of cooks and keep up cooking skills, or the need to maintain a cooking environment, automation of cooking is in urgent need, and there is an increasing demand for an automatic cooking facility that achieves cooking automation.

A known example of such an automatic cooking facility is an automatic taco cooking machine that includes a sauce supply device that, after minced meat is supplied to the inside of a taco shell, supplies a spicy sauce, which is called wild sauce and is stored in a sauce tank, to the minced meat to automatically prepare tacos sequentially (for example, PTL 1).

### CITATION LIST

### Patent Literature

PTL 1: Japanese Patent Application Laid-Open No. Hei. 9-131165

### SUMMARY OF INVENTION

### Technical Problem

In the sauce supply device described above, sauce is merely stored in the sauce tank. In a case where sauce ceases to be supplied for a long time, settles down in the sauce tank, and is separated into sauce components, there is a concern that only one sauce component in the settling separation state may be supplied and that a desired dish that follows a recipe may not be able to be cooked.

The present invention solves the aforementioned problems of the conventional technique, and an object of the present invention is to provide an automatic sauce supply device that automatically supplies a cooking container with sauce in a well-agitated state and a sauce storage facility provided with the same.

### Solution to Problem

The invention according to claim 1 provides an automatic sauce supply device configured to supply a cooking container with sauce contained in a storage container, the automatic sauce supply device comprising at least a container-holding unit configured to hold the storage container that contains the sauce, an ejection nozzle configured to eject the sauce into the cooking container, and a pump configured to pump the sauce from the storage container and pressure-feed the sauce to the ejection nozzle, wherein the container-holding unit includes a base table equipped with the ejection nozzle and the pump, a container-fixing table configured to removably fix the storage container, and a container-shaking mechanism configured to shake the container-fixing table with respect to the base table, thereby solving the problems described above.

In the invention according to claim 2, in addition to the configuration of the automatic sauce supply device according to claim 1, the container-shaking mechanism of the container-holding unit includes an eccentric connection mechanism including an eccentric joint that connects a motor shaft of a shaking motor provided at the base table to a base plate provided at the container-fixing table in an eccentric state, and the container-shaking mechanism swirls the container-fixing table with respect to the base table so as to shake the storage container.

In the invention according to claim 3, in addition to the configuration of the automatic sauce supply device according to claim 1, the container-holding unit includes a self-rotation inhibition mechanism configured to inhibit self-rotation of the container-fixing table, thereby further solving the problems described above.

In the invention according to claim 4, in addition to the configuration of the automatic sauce supply device according to claim 1, a pumping hose connected at one end to the storage container and connected at the other end to the pump is held by a hose holder of the base table, thereby solving the problems described above.

In the invention according to claim 5, in addition to the configuration of the automatic sauce supply device according to claim 1, the container-fixing table holds the storage container at a plurality of positions in a vertical direction, thereby solving the problems described above.

In the invention according to claim 6, in addition to the configuration of the automatic sauce supply device according to claim 1, further comprising a control unit wherein, intermittently executes shaking of the container-fixing table by means of the container-shaking mechanism of the container-holding unit, thereby further solving the problems described above.

In the invention according to claim 7, in addition to the configuration of the automatic sauce supply device according to claim 1, further comprising a control unit wherein, while shaking of the container-fixing table is stopped, the control unit causes the sauce to be pumped by the pump, thereby further solving the problems described above.

The invention according to claim 8 provides a sauce storage facility including the automatic sauce supply device according to claim 1, and a temperature-maintaining chamber configured to incorporate the automatic sauce supply device and maintain a temperature of the sauce in the storage container, wherein the temperature-maintaining chamber includes an opening portion opened directly below the ejection nozzle of the automatic sauce supply device and opposed to the cooking container, thereby further solving the problems described above.

### Advantageous Effects of Invention

The automatic sauce supply device of the present invention includes the container-holding unit configured to hold the storage container that has a bottomed cylindrical form and that contains the sauce, the ejection nozzle configured to eject the sauce into the bottomed cooking container, the pump configured to pump the sauce from the storage container and pressure-feed the sauce to the ejection nozzle, and the control unit configured to drive and control the container-holding unit and the pump. As a result, the automatic sauce supply device according to the present invention can not only automatically supply the cooking container with the sauce contained in the storage container but can also achieve the following advantageous effects specific to the present invention.

That is, with the automatic sauce supply device according to claim 1, the container-holding unit includes the base table equipped with the ejection nozzle and the pump, the container-fixing table configured to removably fix the storage container, and the container-shaking mechanism configured to swirl the container-fixing table with respect to the base table in the horizontal plane so as to shake the storage container. As a result, the container-fixing table is shaken together with the storage container with respect to the base table, so that the sauce in the storage container is agitated. Because of this effect, the sauce will not settle down or be separated into sauce components. Moreover, even in a case where the sauce contained in the storage container is a paste, the sauce can automatically be supplied to the cooking container via the ejection nozzle in a well-agitated state.

With the automatic sauce supply device according to claim 2, which achieves the advantageous effects of the automatic sauce supply device according to claim 1, the container-shaking mechanism of the container-holding unit includes the eccentric connection mechanism including the eccentric joint that connects the motor shaft of the shaking motor provided at the base table to the base plate provided at the container-fixing table in an eccentric state. As a result, the base plate of the container-fixing table is swirled in the horizontal plane around the motor shaft of the base table with a simple mechanism. Because of this effect, the storage container held by the container-fixing table is shaken in the horizontal plane, so that the sauce in the storage container can be shaken uniformly.

With the automatic sauce supply device according to claim 3, which achieves the advantageous effects of the automatic sauce supply device according to claim 1 or 2, the container-holding unit includes the self-rotation inhibition mechanism configured to inhibit self-rotation of the container-fixing table. As a result, when the container-fixing table is shaken with respect to the base table, the container-fixing table is rotated around the base table without self-rotating, and the sauce contained in the storage container can be agitated more reliably.

With the automatic sauce supply device according to claim 4, which achieves the advantageous effects of the automatic sauce supply device according to any one of claims 1 to 3, the pumping hose, which is connected at one end to the storage container and connected at the other end to the pump, is held by the hose holder of the base table. As a result, random movement of the pumping hose due to shaking of the container-fixing table with respect to the base table is inhibited by the hose holder, and twisting or tangling of the entire pumping hose due to shaking of the storage container can be prevented.

With the automatic sauce supply device according to claim 5, which achieves the advantageous effects of the automatic sauce supply device according to any one of claims 1 to 4, the container-fixing table holds the storage container at a plurality of positions in the vertical direction. As a result, when the container-fixing table is shaken with respect to the base table, the storage container is less likely to be inclined away from the vertical direction with respect to the container-fixing table than in a case where the container-fixing table holds the storage container at one position in the vertical direction. Because of this effect, when the container-fixing table is shaken with respect to the base table, it is possible to prevent the storage container from falling with respect to the container-fixing table and to prevent the intake opening in the storage container from being positioned further on the upper side than the sauce level of the sauce because of the sauce level of the sauce in the storage container being inclined.

With the automatic sauce supply device according to claim 6, which achieves the advantageous effects of the automatic sauce supply device according to any one of claims 1 to 5, the control unit intermittently executes shaking of the container-fixing table by means of the container-shaking mechanism of the container-holding unit. As a result, the sauce in the storage container is agitated while the container-fixing table is being shaken with respect to the base table, and the sauce level of the sauce in the storage container is less likely to fluctuate while the container-fixing table is not being shaken with respect to the base table. Because of this effect, the intake opening in the storage container, which communicates with the pump, is, with high certainty, positioned further on the lower side than the sauce level of the sauce, and even in a case where the amount of the sauce stored in the storage container is small, the sauce contained in the storage container can be pumped by the pump more reliably.

With the automatic sauce supply device according to claim 7, which achieves the advantageous effects of the automatic sauce supply device according to any one of claims 1 to 6, the storage container includes the bottom portion having the truncated conical form. As a result, even in a case where the remaining amount of the sauce in the storage container is small, the sauce level of the sauce can be maintained higher due to the truncated conical form than in a case where the bottom portion of the storage container is flat. Furthermore, while shaking of the container-fixing table is stopped, the control unit causes the sauce to be pumped by the pump. As a result, the sauce is pumped at times when the fluctuation of the sauce level of the sauce agitated in the storage container is small. This effect facilitates the intake opening in the storage container, which communicates with the pump, being positioned further on the lower side than the level of the sauce. As a result, even in a case where the amount of the sauce stored in the storage container is small, almost every last drop of the sauce contained in the storage container can be pumped.

The sauce storage facility according to claim 8 includes the automatic sauce supply device according to any one of claims 1 to 7, and the temperature-maintaining chamber configured to incorporate the automatic sauce supply device and maintain the temperature of the sauce in the storage container. The temperature-maintaining chamber includes the opening portion, which is opened directly below the ejection nozzle of the automatic sauce supply device and is opposed to the cooking container. As a result, a predetermined amount of the sauce maintained at a predetermined temperature is supplied to the cooking container, and it is possible to store the sauce at an appropriate temperature and automatically supply a required amount of ingredients for cooking a dish to the cooking container.

### BRIEF DESCRIPTION OF DRAWINGS

FIG. 1 is a front view of a sauce storage facility according to an embodiment of the present invention.

FIG. 2 is a perspective view of an automatic sauce supply device illustrated in FIG. 1.

FIG. 3 is a cross-sectional view take along line III-III in FIG. 1.

FIG. 4 is a partial cross-sectional view taken along line IV-IV in FIG. 3.

FIG. 5 is a configuration diagram of the automatic sauce supply device illustrated in FIG. 1.

FIG. 6 is a cross-sectional view of a storage container and the peripheral structure of the storage container illustrated in FIG. 1.

FIG. 7 is a schematic view illustrating the operation of the automatic sauce supply device illustrated in FIG. 1.

### DESCRIPTION OF EMBODIMENTS

A specific embodiment of the present invention may be any automatic sauce supply device that supplies a cooking container with sauce contained in a storage container, that includes a container-holding unit configured to hold the storage container that has a bottomed cylindrical form and that contains the sauce, an ejection nozzle configured to eject the sauce into the cooking container having a bottom, a pump configured to pump the sauce from the storage container and pressure-feed the sauce to the ejection nozzle, and a control unit configured to drive and control the container-holding unit and the pump, in which the container-holding unit includes a base table equipped with the pump and the ejection nozzle, a container-fixing table configured to removably fix the storage container, and a container-shaking mechanism configured to swirl the container-fixing table with respect to the base table in a horizontal plane so as to shake the storage container, and that automatically supplies the cooking container with the sauce in a well-agitated state.

For example, an automatic sauce supply device of the present invention is mainly installed in restaurants. However, the automatic sauce supply device of the present invention may be installed in not only restaurants but also food courts, business offices, homes, or the like.

For example, the automatic sauce supply device of the present invention supplies a cooking container with sauce. However, a supply target for sauce by the automatic sauce supply device of the present invention is not limited to a cooking container, and the automatic sauce supply device may directly supply, for example, an ingredient with sauce.

For example, the sauce stored in the automatic sauce supply device of the present invention is a collective term for liquid or paste seasoning agents that garnish food or is used for cooking. Examples thereof include not only liquid seasoning agents such as soy sauce, vinegar, oil, sweet cooking rice wine called mirin, and cooking sake but also paste seasoning agents such as pasta sauces such as tomato sauce, basil sauce, and meat sauce, Worcestershire sauce, mayonnaise, ketchup, oyster sauce, sauce for fried noodles, gravy sauce, bechamel sauce, tartar sauce, chili sauce, apple sauce, cranberry sauce, and custard sauce.

### First Embodiment

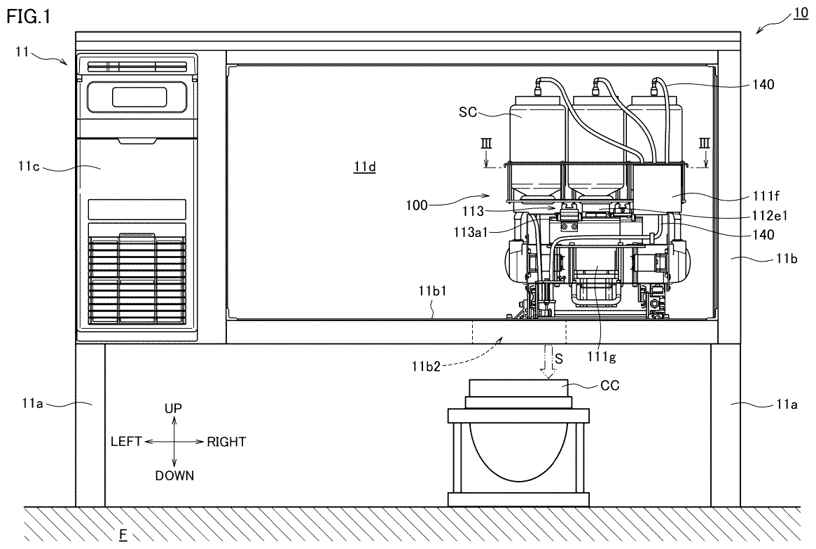

Hereinbelow, an automatic sauce supply device 100 and a sauce storage facility 10 provided with the same according to an embodiment of the present invention will be described on the basis of FIG. 1 to FIG. 7.

### <1. Overview of Sauce Storage Facility>

First, an overview of the sauce storage facility 10 will be described on the basis of FIG. 1, which is a front view of the sauce storage facility according to the embodiment of the present invention.

Note that FIG. 1 omits a door provided on the front side of the sauce storage facility 10 to separate a storage space 11d from the outside for the sake of description.

As illustrated in FIG. 1, the sauce storage facility 10 includes a temperature-maintaining chamber 11, which is installed on an installation surface F and stores sauce or the like at a certain temperature, and also includes the automatic sauce supply device 100 incorporated in the temperature-maintaining chamber 11.

As illustrated in FIG. 1, the temperature-maintaining chamber 11 includes a leg 11a that extends from the installation surface F, a hollow box-like temperature-maintaining chamber main body 11b that is installed at a position away from the installation surface F because of the leg 11a, and a temperature-maintaining control unit 11c that is provided on the left side of the temperature-maintaining chamber main body 11b and controls the temperature-maintaining chamber 11.

As illustrated in FIG. 1, the temperature-maintaining chamber main body 11b is open on the front side (on the foreside) and is provided with the storage space 11d formed therein.

Also, on the front surface of the temperature-maintaining chamber main body 11b, an openable and closable door (not illustrated) is provided.

A device-mounting surface 11b1 serving as the bottom surface of the temperature-maintaining chamber main body 11b is provided with an opening portion 11b2 opened in the up-down direction and opposed to a cooking container CC.

Therefore, the cooking container CC is installed directly below the opening portion 11b2.

### <2. Automatic Sauce Supply Device>

Next, an overview of the automatic sauce supply device 100 will be described on the basis of FIG. 1 to FIG. 5.

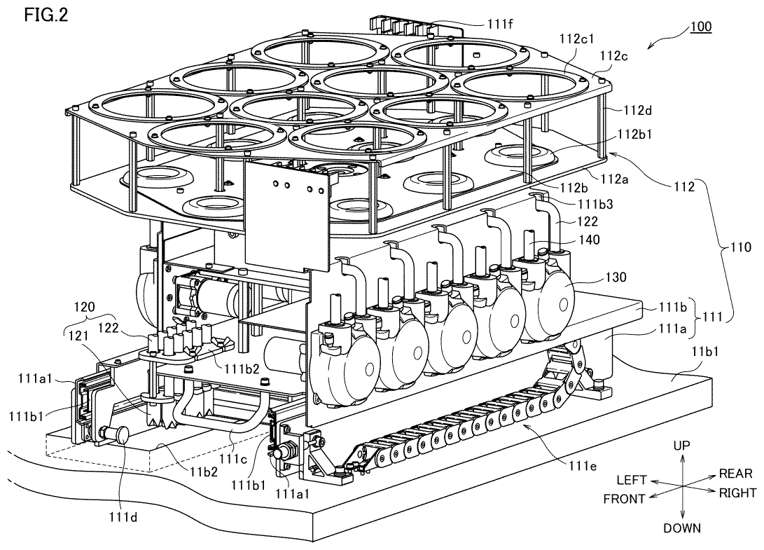

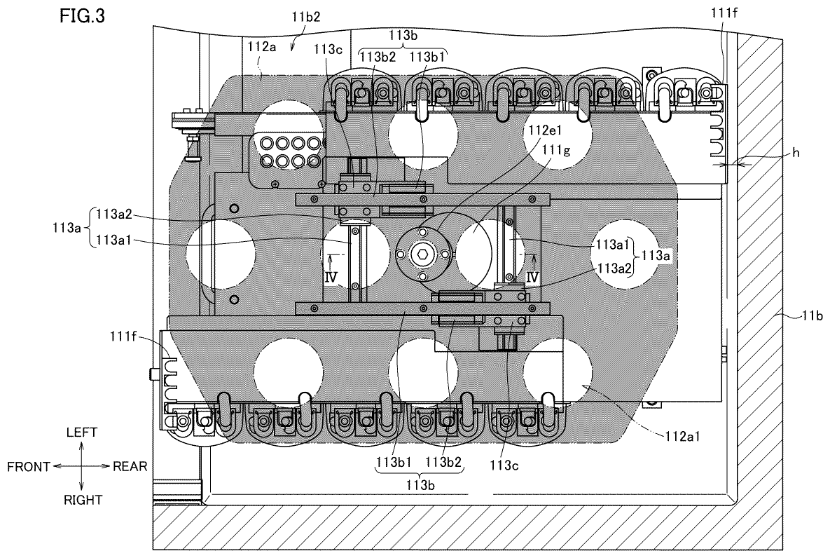

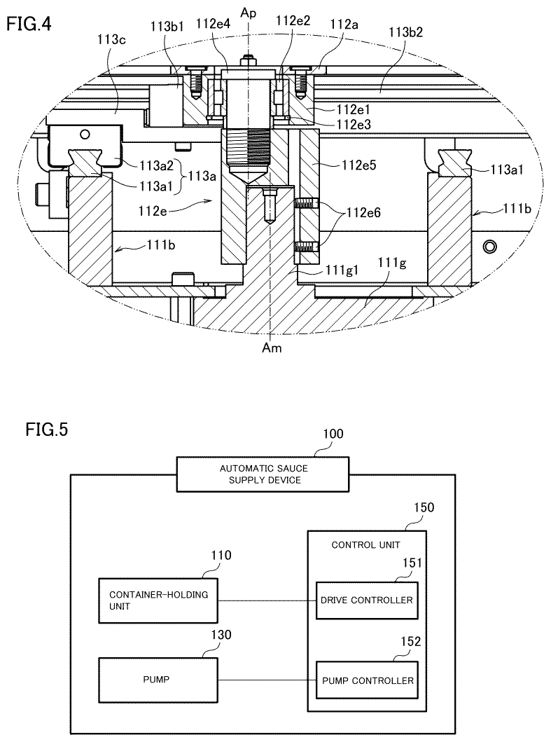

FIG. 2 is a perspective view of the automatic sauce supply device illustrated in FIG. 1, FIG. 3 is a cross-sectional view taken along line III-III in FIG. 1, FIG. 4 is a partial cross-sectional view taken along line IV-IV in FIG. 3, and FIG. 5 is a configuration diagram of the automatic sauce supply device illustrated in FIG. 1.

Note that FIG. 2 and FIG. 3 illustrate a state in which the automatic sauce supply device 100 is housed in the temperature-maintaining chamber 11.

Also, in FIG. 3 and FIG. 4, for the sake of description, a holding member attaching plate 112b, a container bottom portion holding member 112b1, an upper plate 112c, a connection member 112d, and the like are removed, and a base plate 112a is outlined by a virtual line and shaded.

The automatic sauce supply device 100 is a device configured to hold a bottomed-cylindrical storage container SC that contains sauce S and supplies the cooking container CC with the sauce S. The automatic sauce supply device 100 is mounted on the device-mounting surface 11b1 (that is, in the storage space 11d) of the temperature-maintaining chamber 11 as illustrated in FIG. 1.

As illustrated in FIG. 2, the automatic sauce supply device 100 includes a container-holding unit 110 configured to hold the storage container SC, an ejection nozzle 120 configured to eject the sauce S into the bottomed cooking container CC (refer to FIG. 1), a pump 130 configured to pump the sauce S from the storage container SC and pressure-feed the sauce S to the ejection nozzle 120, and a pumping hose 140 connected at one end to the storage container SC and connected at the other end to the pump 130.

As illustrated in FIG. 5, the automatic sauce supply device 100 further includes a control unit 150 configured to drive and control the container-holding unit 110 and the pump 130.

The control unit 150 includes a drive controller 151 configured to control the container-holding unit 110 and a pump controller 152 configured to control the pump 130.

### <2.1. Container-Holding Unit>

As illustrated in FIG. 2, the container-holding unit 110 includes a base table 111 mounted on the device-mounting surface 11b1 of the temperature-maintaining chamber 11 and equipped with the ejection nozzle 120 and the pump 130, and a container-fixing table 112 that is mounted on the base table 111 and configured to removably fix the storage container SC.

### <2.1.1. Base Table>

As illustrated in FIG. 2, the base table 111 includes: a fixing portion 111a fixed on the device-mounting surface 11b1 of the temperature-maintaining chamber 11; a movable portion 111b slidable with respect to the fixing portion 111a; a handle 111c attached to the front end of the movable portion 111b and used to draw the movable portion 111b with respect to the fixing portion 111a; a lock pin 111d enabling the movable portion 111b to be fixed to the fixing portion 111a; a cable guide 111e fixed to the fixing portion 111a and the movable portion 111b and enabling a cable to be inserted therein; a hose holder 111f provided at the movable portion 111b and holding the pumping hose 140; and a shaking motor 111g provided at the movable portion 111b.

As illustrated in FIG. 2, a pair of right and left rail guides 111al extending in the front-rear direction is attached to the fixing portion 111a.

As illustrated in FIG. 2, a pair of right and left rails 111b1 that are slidably engaged with the rail guides 111al of the fixing portion 111a and extend in the front-rear direction is attached to the movable portion 111b.

Also, on the front left side of the movable portion 111b, a nozzle attaching plate 111b2 to which the ejection nozzle 120 is attached is provided.

The lock pin 111d is an index plunger whose pin tip end is movable in the axial direction (the right-left direction in the present embodiment) and is attached on the front end side of the movable portion 111b.

When the lock pin 111d is pulled, engagement between the lock pin 111d and the fixing portion 111a is released to cause the movable portion 111b to be movable with respect to the fixing portion 111a. When the lock pin 111d is not pulled, the lock pin 111d and the fixing portion 111a are engaged with each other, and the movable portion 111b is fixed to the fixing portion 111a.

The cable guide 111e has the power supply cable and the like of the shaking motor 111g described below inserted therein to inhibit the power supply cable and the like from being disorganized when the movable portion 111b moves with respect to the fixed portion 111a.

As illustrated in FIG. 2 and FIG. 3, the hose holders 111f are provided at the front end and the rear end of the movable portion 111b, respectively.

Each of the hose holders 111f is elastically deformable to the extent of being able to removably hold the pumping hose 140.

Also, as illustrated in FIG. 3, the hose holder 111f provided on the rear end side of the movable portion 111b is away from the temperature-maintaining chamber main body 11b by a distance h.

Furthermore, the shaking motor 111g described above is provided with a motor shaft 111g1 extending in the up-down direction.

### <2.1.2. Container-Fixing Table>

As illustrated in FIG. 2, the container-fixing table 112 includes: the flat-plate-like base plate 112a attached to the base table 111; the flat-plate-like holding member attaching plate 112b mounted on the base plate 112a; the upper plate 112c opposed to and away from the base plate 112a in the up-down direction; the rod-like connection member 112d connecting the base plate 112a to the upper plate 112c; and an eccentric connection mechanism 112e connecting the base plate 112a to the shaking motor 111g of the base table 111 in an eccentric state.

As illustrated in FIG. 3, the base plate 112a has an octagonal shape and is provided with ten circular openings 112a1.

As illustrated in FIG. 2, the holding member attaching plate 112b has a hexagonal shape and has a smaller area than the base plate 112a in a planar view.

The holding member attaching plate 112b is provided with ten circular holding member attaching holes (not illustrated), and each of the circular holding member attaching holes has fitted therein the rubber-made annular container bottom portion holding member 112b1.

The upper plate 112c has a shape that is substantially equal to that of the base plate 112a in a planar view, and as illustrated in FIG. 2, is provided with ten circular openings, and each of the circular openings has a rubber-made annular container side portion holding member 112cl fitted therein.

As illustrated in FIG. 4, the eccentric connection mechanism 112e described above includes: an annular bearing holder 112e1 screwed to the base plate 112a; an annular roller bearing 112e2 inserted in the bearing holder 112e1; a falling prevention tool 112e3 configured to prevent the roller bearing 112e2 from falling off the bearing holder 112e1; a rotation shaft member 112e4 inserted in the roller bearing 112e2; an eccentric joint 112e5 that connects the rotation shaft member 112e4 to the motor shaft 111g1 of the base table 111; and a fixing screw 112e6 that fixes the motor shaft 111g1 of the base table 111 to the eccentric joint 112e5.

As illustrated in FIG. 4, the falling prevention tool 112e3 is engaged with the bearing holder 112e1 and is opposed to the outer ring side of the roller bearing 112e2 in the up-down direction.

As illustrated in FIG. 3, the rotation shaft member 112e4 is arranged substantially at the center of the container-fixing table 112.

Also, as illustrated in FIG. 4, a screw is formed at the tip end of the rotation shaft member 112e4, and is screwed in the eccentric joint 112e5.

The eccentric joint 112e5 is a cylindrical member. The rotation shaft member 112e4 is screwed onto the eccentric joint 112e5 from the upper side thereof while the motor shaft 111g1 is inserted from the lower side thereof.

As illustrated in FIG. 4, the fixing screw 112e6 abuts on the lateral side of the motor shaft 111g1 and presses the motor shaft 111g1 toward the eccentric joint 112e5.

Therefore, as illustrated in FIG. 4, a rotation axis Am of the shaking motor 111g is eccentric to a center axis Ap of the container-fixing table 112 (the center axis of the rotation shaft member 112e4).

### <2.1.3. Self-Rotation Inhibition Unit>

The container-holding unit 110 further includes a self-rotation inhibition mechanism 113 configured to inhibit self-rotation of the container-fixing table 112.

The self-rotation inhibition mechanism 113 includes a right-left direction guide 113a configured to restrict movement of the container-fixing table 112 in the front-rear direction, a front-rear direction guide 113b configured to restrict movement of the container-fixing table 112 in the right-left direction, and a connection block 113c configured to connect the right-left direction guide 113a to the front-rear direction guide 113b.

As the right-left direction guide 113a, a linear motion mechanism such as an LM guide mechanism is used. For example, the right-left direction guide 113a is constituted by a right-left direction rail 113a1 and a right-left direction guide table 113a2 mounted on the right-left direction rail 113a1. Herein, the guide table 113a2 is slidable on the right-left direction rail 113a1.

As illustrated in FIG. 1, FIG. 3, and FIG. 4, the right-left direction rail 113a1 is a pair of front and rear rails extending in the right-left direction and is mounted on the movable portion 111b of the base table 111.

As the front-rear direction guide 113b, a linear motion mechanism such as an LM guide mechanism is used. For example, as illustrated in FIG. 3 and FIG. 4, the front-rear direction guide 113b is constituted by a front-rear direction guide portion 113b1 and a front-rear direction rail 113b2 slidable in the front-rear direction by the front-rear direction guide portion 113b1.

The front-rear direction guide portion 113b1 is attached to the right-left direction guide table 113a2 and is movable in the right-left direction integrally with the right-left direction guide table 113a2.

As illustrated in FIG. 3, the front-rear direction rail 113b2 is a pair of right and left rails extending in the front-rear direction and is fixed to the container-fixing table 112.

As illustrated in FIG. 2 and FIG. 3, the connection block 113c connects the right-left direction guide table 113a2 of the right-left direction guide 113a to the front-rear direction guide portion 113b1 of the front-rear direction guide 113b.

### <2.2. Ejection Nozzle, Pump, and Pumping Hose>

As illustrated in FIG. 2, the ejection nozzle 120 includes a nozzle head 121 attached to the movable portion 111b of the base table 111 and a nozzle hose 122 connected at one end to the nozzle head 121 and connected at the other end to the pump 130.

The nozzle head 121 is a member made of a resin (for example, a silicon resin). The nozzle head 121 is normally in a closed state, but when the sauce S flows into it, the nozzle head 121 is made to be in an opened state by the flow pressure. Also, as illustrated in FIG. 2, the opening portion 11b2 of the temperature-maintaining chamber 11 is located directly below the nozzle head 121.

The nozzle hose 122 is flexible to the extent of being able to extend from the pump 130 and be inserted into a hose insertion hole 111b3 (refer to FIG. 2) of the movable portion 111b.

As illustrated in FIG. 2, as many pumps 130 as the number of the storage containers SC (the number is ten in the present embodiment) are attached to both the side surfaces of the movable portion 111b of the base table 111 of the container-holding unit 110.

Therefore, at the time of maintenance, each of the pumps 130 can be removed easily from the temperature-maintaining chamber 11.

The pumping hose 140 is flexible to the extent of being able to follow shaking of the container-fixing table 112 with respect to the base table 111, and as illustrated in FIG. 1, is partially held by the hose holder 111 f.

### <3. Structure of Storage Container and Holding by Container-Holding Unit>

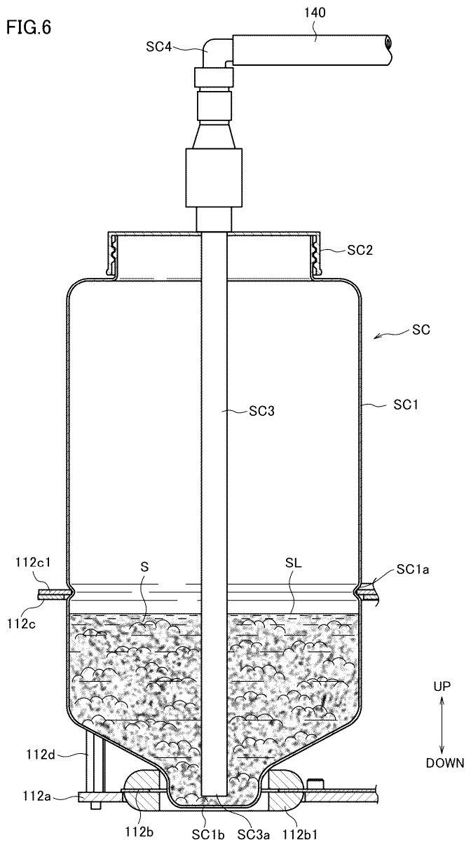

Next, a structure of the storage container SC and holding of the storage container SC by the container-holding unit 110 will be described on the basis of FIG. 6, which is a cross-sectional view of the storage container and the peripheral structure of the storage container illustrated in FIG. 1.

Note that, in FIG. 6, some members behind the storage container SC are omitted for simplification.

### <3.1. Structure of Storage Container SC>

The storage container SC includes: a transparent container main body SC1 that can have its content be visually recognized; a cap SC2 screwed at the upper opening portion of the container main body SC1 to close the upper opening portion of the container main body SC1; a pipe SC3 inserted in the cap SC2, one end of which is submerged in the sauce S which serves as an intake opening SC3a; and an inverted L-shaped joint SC4 connected to the other end of the pipe SC3 and also connected to the pumping hose 140.

The container main body SC1 has a bottomed cylindrical form, and the cylindrical body portion of the container main body SC1 is provided with a narrow portion SC1a as illustrated in FIG. 6.

Also, a bottom portion SC1b of the container main body SC1 has a truncated conical form, wherein the diameter thereof is smaller than the body portion as illustrated in FIG. 6.

### <3.2. Holding of Storage Container SC by Container-Holding Unit 110>

As illustrated in FIG. 6, the storage container SC is inserted in the upper plate 112c of the container-fixing table 112.

The container side portion holding member 112cl of the container-fixing table 112 is engaged with the narrow portion SC1a of the storage container SC, and the bottom portion SC1b of the storage container SC is inserted in the container bottom portion holding member 112b1.

Therefore, the body portion of the storage container SC is held by the container side portion holding member 112cl of the container-fixing table 112, and the bottom portion SC1b of the storage container SC is held by the container bottom portion holding member 112b1 of the container-fixing table 112.

That is, the container-fixing table 112 holds the storage container SC at a plurality of positions in the vertical direction.

### <4. Automatic Supply of Sauce>

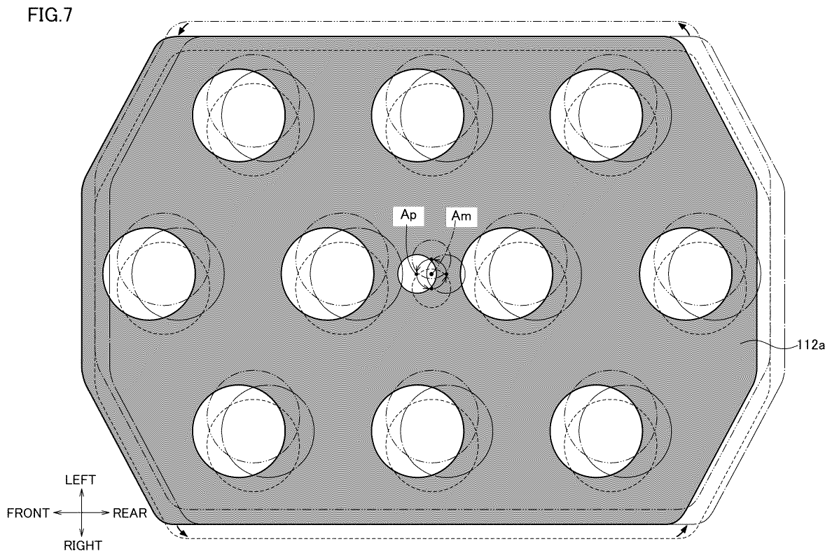

Next, an example of a procedure for automatic supply of sauce contained in the storage container SC by means of the automatic sauce supply device 100 will be described on the basis of FIG. 2, FIG. 3, and FIG. 7, which is a schematic view illustrating the operation of the automatic sauce supply device illustrated in FIG. 1, and the like.

### <4.1. Overview>

The control unit 150 intermittently executes shaking of the container-fixing table 112 by means of the eccentric connection mechanism 112e that serves as a container-shaking mechanism.

When an instruction to supply sauce is input from outside, the control unit 150 stops shaking of the container-fixing table 112 by means of the eccentric connection mechanism 112e of the container-holding unit 110, pumps the sauce S from the storage container SC by means of the pump 130, and ejects the sauce S from the ejection nozzle 120.

That is, in the present embodiment, while shaking of the container-fixing table 112 by means of the eccentric connection mechanism 112e of the container-holding unit 110 is stopped, the sauce S is pumped from the storage container SC by the pump 130 and is ejected by the ejection nozzle 120.

### <4.2. Shaking of Storage Container>

Next, shaking of the storage container SC by means of the control unit 150 will be described.

The control unit 150 operates the container-holding unit 110 to cause the storage container SC to be shaken. Specifically, the control unit 150 causes the shaking motor 111g attached to the base table 111 to be driven.

When the motor shaft 111g1 is rotated in one direction by driving of the shaking motor 111g, the eccentric joint 112e5 is rotated in one direction integrally with the motor shaft 111g1, and the rotation shaft member 112e4, which is screwed onto the eccentric joint 112e5, is also rotated.

At this time, as the rotation shaft member 112e4 is pivotally supported by the roller bearing 112e2 attached to the container-fixing table 112, self-rotation of the rotation shaft member 112e4 is not transmitted to the container-fixing table 112.

On the other hand, as the center axis Ap of the rotation shaft member 112e4 is eccentric to the rotation axis Am of the shaking motor 111g, the rotation shaft member 112e4 is rotated around the motor shaft 111g1 of the shaking motor 111g, as shown in the planar view illustrated in FIG. 3.

Since the container-fixing table 112, which includes the roller bearing 112e2 pivotally supporting the rotation shaft member 112e4, is not fixed to the base table 111, the container-fixing table 112 is also rotated around the motor shaft 111g1 of the base table 111.

Here, the container-fixing table 112 can move only in the front-rear and right-left directions with respect to the base table 111 due to the self-rotation inhibition mechanism 113. For this reason, when the container-fixing table 112 is rotated around the motor shaft 111g1 of the shaking motor 111g, the container-fixing table 112 cannot be self-rotated around the center axis Ap of the rotation shaft member 112e4.

As a result, when the control unit 150 rotates the shaking motor 111g, as illustrated in FIG. 7, the container-fixing table 112 (that is, the center axis Ap of the container-fixing table 112) is swirled, without a change in the posture, around the motor shaft 111g1 (that is, the rotation axis Am of the motor 111g) of the base table 111 in the horizontal plane.

Because of this effect, the storage container SC held in the container-fixing table 112 is shaken in the horizontal plane, and the sauce S in the storage container SC is also shaken.

That is, in the present invention, the shaking motor 111g of the base table 111 and the eccentric connection mechanism 112e of the container-fixing table 112 rotate the container-fixing table 112 with respect to the base table 111, to function as the container-shaking mechanism that swirls and oscillates the container-fixing table 112 with respect to the base table 111 in the horizontal plane so as to shake the storage container SC.

### <5. Effects of Source Storage Facility 10 and Automatic Sauce Supply Device 100>

The sauce storage facility 10 described above includes the automatic sauce supply device 100 and the temperature-maintaining chamber 11 configured to incorporate the automatic sauce supply device 100 and maintain the temperature of the sauce S in the storage container SC. The temperature-maintaining chamber 11 includes the opening portion 11b2 opened directly below the ejection nozzle 120 of the automatic sauce supply device 100 and opposed to the cooking container CC. As a result, a predetermined amount of the sauce S maintained at a predetermined temperature is supplied to the cooking container CC, and it is possible to store the sauce S at an appropriate temperature and automatically supply a required amount of ingredient for cooking a dish to the cooking container CC.

Also, with the automatic sauce supply device 100 described above, the container-holding unit 110 includes the container-shaking mechanism (the shaking motor 111g and the eccentric connection mechanism 112e) configured to swirl the container-fixing table 112 with respect to the base table in the horizontal plane so as to shake the storage container SC. As a result, the container-fixing table 112 is shaken together with the storage container SC with respect to the base table 111, so that the sauce S in the storage container SC is agitated. Because of this effect, the sauce S contained in the storage container SC will not settle down or be separated into sauce components. Moreover, even in a case where the sauce S contained in the storage container SC is a paste, the sauce S can automatically be supplied to the cooking container CC via the ejection nozzle 120 in a well-agitated state.

Also, the container-shaking mechanism of the container-holding unit 110 includes the eccentric connection mechanism 112e, which includes the eccentric joint 112e5 that connects the motor shaft 111g1 of the shaking motor 111g provided at the base table 111 to the base plate 112a provided at the container-fixing table 112 in an eccentric state. As a result, the base plate 112a of the container-fixing table 112 is swirled in the horizontal plane around the motor shaft 111g1 of the base table 111 with a simple mechanism, and the storage container SC held by the container-fixing table 112 is shaken in the horizontal plane, so that the sauce S in the storage container SC can be shaken uniformly.

Furthermore, the container-holding unit 110 includes the self-rotation inhibition mechanism 113 configured to inhibit self-rotation of the container-fixing table 112. As a result, when the container-fixing table 112 is shaken with respect to the base table 111, the container-fixing table 112 is rotated around the base table 111 without self-rotating, and the sauce S contained in the storage container SC can be agitated more reliably.

Also, the pumping hose 140, which is connected at one end to the storage container SC and connected at the other end to the pump 130, is held by the hose holder 111f of the base table 111. As a result, random movement of the pumping hose 140 due to shaking of the container-fixing table 112 with respect to the base table 111 is inhibited by the hose holder 111f, and twisting or tangling of the entire pumping hose 140 due to shaking of the storage container SC can be prevented.

Also, the container-fixing table 112 holds the storage container SC at the two positions in the vertical direction. As a result, when the container-fixing table 112 is shaken with respect to the base table 111, the storage container SC is less likely to be inclined away from the vertical direction with respect to the container-fixing table 112 than in a case where the container-fixing table 112 holds the storage container SC at one position in the vertical direction. Because of this effect, when the container-fixing table 112 is shaken with respect to the base table 111, it is possible to prevent the storage container SC from falling with respect to the container-fixing table 112 and to prevent the intake opening SC3a in the storage container SC from being positioned further on the upper side than a sauce level SL (refer to FIG. 6) of the sauce S because of the sauce level SL of the sauce S in the storage container SC being inclined.

Also, the control unit 150 intermittently executes shaking of the container-fixing table 112 by means of the container-shaking mechanism of the container-holding unit 110. As a result, the sauce S in the storage container SC is agitated while the container-fixing table 112 is being shaken with respect to the base table 111, and the sauce level SL of the sauce S in the storage container SC is less likely to fluctuate while the container-fixing table 112 is not being shaken with respect to the base table 111. Because of this effect, the intake opening SC3a in the storage container SC, which communicates with the pump 130, is, with high certainty, positioned further on the lower side than the sauce level SL of the sauce S, and even in a case where the amount of the sauce S stored in the storage container SC is small, the sauce S contained in the storage container SC can be pumped by the pump 130 more reliably.

Furthermore, the storage container SC includes the bottom portion SC1b having the truncated conical form. As a result, even in a case where the remaining amount of the sauce S in the storage container SC is small, the sauce level of the sauce S can be maintained higher due to the truncated conical form than in a case where the bottom portion SC1b of the storage container SC is flat. Furthermore, while shaking of the container-fixing table 112 is stopped, the control unit 150 causes the sauce S to be pumped by the pump 130. As a result, the sauce S is pumped at times when the fluctuation of the sauce level of the sauce S agitated in the storage container SC is small. This effect facilitates the intake opening SC3a in the storage container SC, which communicates with the pump 130, being positioned further on the lower side than the sauce level SL of the sauce S. As a result, even in a case where the amount of the sauce S stored in the storage container SC is small, almost every last drop of the sauce S contained in the storage container SC can be pumped.

### Modification Examples

Although the sauce storage facility and the automatic sauce supply device according to an embodiment of the present invention have been described above, the sauce storage facility and the automatic sauce supply device of the present invention are not limited to the sauce storage facility and the automatic sauce supply device according to the embodiment described above.

For example, the temperature of the sauce maintained by the sauce storage facility of the present invention may be zero degrees or lower, about four degrees, or any degrees.

For example, in the above-described embodiment, the automatic sauce supply device 100 has ten storage containers SC and can automatically supply ten types of sauces. However, the number of the storage containers held by the automatic sauce supply device and the number of types of sauces supplied by the automatic sauce supply device are not limited to these. For example, in the above-described embodiment, the container-fixing table 112 holds the storage container SC at two positions in the vertical direction. However, the number of positions at which the container-fixing table holds the storage container may be any number as long as the container-fixing table holds the storage container at a plurality of positions in the vertical direction.

For example, in the above-described embodiment, the sauce S is pumped from the storage container SC by the pump 130 and is ejected by the ejection nozzle 120 while shaking of the container-fixing table 112 by means of the eccentric connection mechanism 112e of the container-holding unit 110 is stopped. However, the sauce may be pumped from the storage container by the pump and be ejected by the ejection nozzle while shaking of the container-fixing table by means of the eccentric connection mechanism of the container-holding unit is in progress.

For example, in the above-described embodiment, the base plate 112a of the automatic sauce supply device 100 is swirled in one direction in the horizontal plane as illustrated in FIG. 7. However, the swirling of the base plate (container-fixing table) in the horizontal plane by means of the automatic sauce supply device is not limited to swirling in one direction and may be, for example, swirling and oscillation in the horizontal plane.

1. An automatic sauce supply device configured to supply a cooking container with sauce contained in a storage container, the automatic sauce supply device comprising at least:
a container-holding unit configured to hold the storage container that contains the sauce;
an ejection nozzle configured to eject the sauce into the cooking container; and
a pump configured to pump the sauce from the storage container and pressure-feed the sauce to the ejection nozzle, wherein
the container-holding unit includes a base table equipped with the ejection nozzle and the pump, a container-fixing table configured to removably fix the storage container, and a container-shaking mechanism configured to shake the container-fixing table with respect to the base table.

2. The automatic sauce supply device according to claim 1, wherein the container-shaking mechanism of the container-holding unit includes an eccentric connection mechanism including an eccentric joint that connects a motor shaft of a shaking motor provided at the base table to a base plate provided at the container-fixing table in an eccentric state, and the container-shaking mechanism swirls the container-fixing table with respect to the base table so as to shake the storage container.

3. The automatic sauce supply device according to claim 1, wherein the container-holding unit includes a self-rotation inhibition mechanism configured to inhibit self-rotation of the container-fixing table.

4. The automatic sauce supply device according to claim 1, wherein a pumping hose connected at one end to the storage container and connected at the other end to the pump is held by a hose holder of the base table.

5. The automatic sauce supply device according to claim 1, wherein the container-fixing table holds the storage container at a plurality of positions in a vertical direction.

6. The automatic sauce supply device according to claim 1, further comprising a control unit wherein, intermittently executes shaking of the container-fixing table by means of the container-shaking mechanism of the container-holding unit.

7. The automatic sauce supply device according to claim 1, further comprising a control unit wherein,
while shaking of the container-fixing table is stopped, the control unit causes the sauce to be pumped by the pump.

8. A sauce storage facility comprising:
the automatic sauce supply device according to claim 1; and
a temperature-maintaining chamber configured to incorporate the automatic sauce supply device and maintain a temperature of the sauce in the storage container, wherein
the temperature-maintaining chamber includes an opening portion opened directly below the ejection nozzle of the automatic sauce supply device and opposed to the cooking container.
